(19) United States
(12) Patent Application Publication
(10) Pub. No.: US 2006/0210131 A1
(43) Pub. Date: Sep. 21, 2006

(54) Tomographic computer aided diagnosis (CAD) with multiple reconstructions

(76) Inventors: Frederick Wilson Wheeler JR., Niskayuna, NY (US); Bernhard Erich Hermann Claus, Niskayuna, NY (US); Ambalangoda Gurunnanselage Amitha Perera, Clifton Park, NY (US); Razvan Gabriel Iordache, Paris (FR)

Correspondence Address: Patrick S. Yoder;FLETCHER YODER, P.O. Box 692289, Houston, TX, 77269-2289, US

(21) Appl. No.: 11/080,121

(22) Filed: Mar. 15, 2005

(51) Int. Cl. G06K 9/00

(52) U.S. Cl. 382/128

(57) ABSTRACT

A method for performing a computer aided detection (CAD) analysis of images acquired from a multiple projection X-ray system is provided. The method comprises accessing the projection images from the multiple projection X-ray system and applying a plurality of reconstruction algorithms on the projection images to generate a plurality of reconstructed images. Then, the method comprises applying a CAD algorithm to the plurality of reconstructed images.

### BACKGROUND

The invention relates generally to medical imaging procedures. In particular, the present invention relates to techniques for improving detection and diagnosis of medical conditions by utilizing computer aided diagnosis or detection techniques.

Computer aided diagnosis or detection (CAD) techniques permit screening and evaluation of disease states, medical or physiological events and conditions. Such techniques are typically based upon various types of analysis of one or a series of collected images. The collected images are analyzed by segmentation, feature extraction, and classification to detect anatomic signatures of pathologies. The results are then generally viewed by radiologists for final diagnosis. Such techniques may be used in a range of applications, such as mammography, lung cancer screening or colon cancer screening.

A CAD algorithm offers the potential for identifying certain anatomic signatures of interest, such as cancer, or other anomalies. CAD algorithms are generally selected based upon the type of signature or anomaly to be identified, and are usually specifically adapted for the imaging modality used to create the image data. These algorithms may employ segmentation algorithms, which partition the image into regions or select points for individual consideration and decisions. Segmentation algorithms may partition the image based on edges, identifiable structures, boundaries, changes or transitions in colors or intensities, changes or transitions in spectrographic information, and so forth.

CAD algorithms may be utilized in a variety of imaging modalities, such as, for example, tomosynthesis systems, computed tomography (CT) systems, X-ray C-arm systems, magnetic resonance imaging (MRI) systems, X-ray systems, ultrasound systems (US), positron emission tomography (PET) systems, and so forth. Each imaging modality is based upon unique physics and image formation and processing techniques, and each imaging modality may provide unique advantages over other modalities for imaging a particular physiological signature of interest or detecting a certain type of disease or physiological condition. CAD algorithms used in each of these modalities may therefore provide advantages over those used in other modalities, depending upon the imaging capabilities of the modality, the tissue being imaged, and so forth.

As will be appreciated by those skilled in the art, CAD processing in a tomography system may be performed on a two-dimensional reconstructed image, on a three-dimensional reconstructed image, or a suitable combination of such formats. CAD processing of tomosynthesis image data typically comprises using a single 2D or 3D reconstructed image as input into a CAD algorithm and computing features for each sample point or segmented region in the reconstructed image, followed by classification and detection. However, as is known to those skilled in the art, reconstruction can be performed using different reconstruction algorithms and different reconstruction parameters to generate images with different characteristics. Furthermore, depending on the particular reconstruction algorithm used, different anatomical signatures or anomalies may be detected with varying degrees of confidence and accuracy by the CAD algorithm. Existing image reconstruction techniques and CAD techniques are typically used independently, and little or no complementary use of such techniques has been attempted in the art.

It would therefore, be desirable to adapt a CAD algorithm to be able to input features that come from several different reconstructions to improve the detection of one or more anatomical signatures of interest.

### BRIEF DESCRIPTION

Embodiments of the present invention address this and other needs. In one embodiment, a method for performing a computer aided detection (CAD) analysis of images acquired from a multiple projection X-ray system is provided. The method comprises accessing the projection images from the multiple projection X-ray system and applying a plurality of reconstruction algorithms on the projection images to generate a plurality of reconstructed images. Then, the method comprises applying a CAD algorithm to the plurality of reconstructed images.

In another embodiment, an imaging system is provided. The imaging system comprises a source of radiation for producing X-ray beams directed at a subject of interest and a detector adapted to detect the X-ray beams. The system further comprises a processor configured to access projection images from the detector. The processor is configured to apply a plurality of reconstruction algorithms to the projection images to generate a plurality of reconstructed images and apply a CAD algorithm to the plurality of reconstructed images.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary imaging system, in this case a tomosynthesis system for producing processed images in accordance with the present technique;

FIG. 2 is a diagrammatical representation of a physical implementation of the system of FIG. 1;

FIG. 3 is a flow chart illustrating exemplary steps for carrying out CAD processing of image data, as applied to tomographic image data from a system of the type illustrated in FIGS. 1 and 2; and

FIG. 4 is an illustration of a CAD system that is configured to operate on multiple reconstructions in accordance with the present technique.

### DETAILED DESCRIPTION

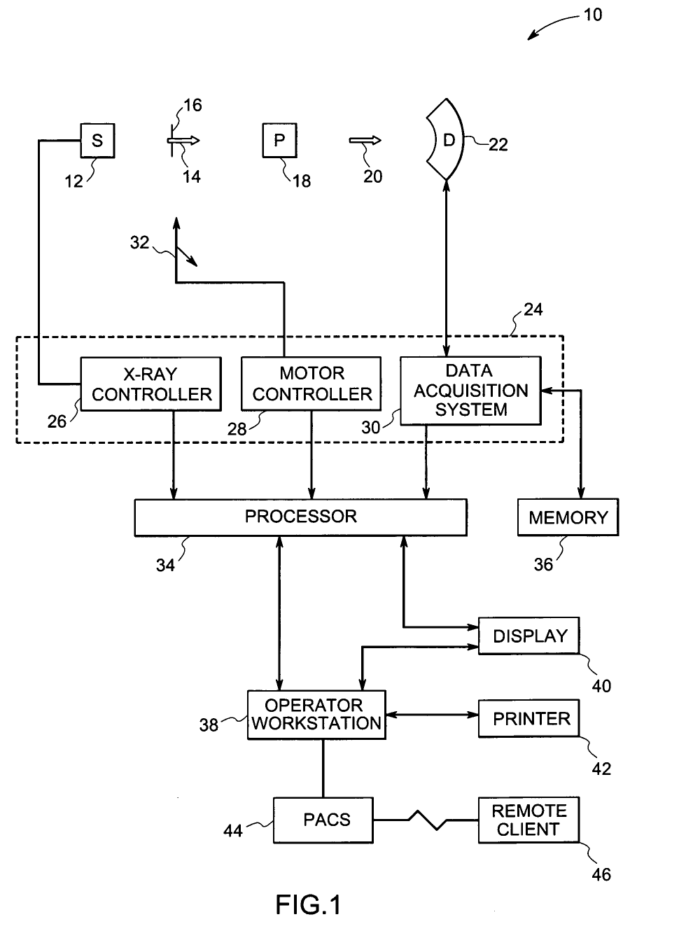

FIG. 1 is a diagrammatical representation of an exemplary imaging system, for acquiring, processing and displaying images in accordance with the present technique. In accordance with a particular embodiment of the present technique, the imaging system is a tomosynthesis system, designated generally by the reference numeral 10, in FIG. 1. However, it should be noted that any multiple projection X-ray imaging system may be used for acquiring, processing and displaying images in accordance with the present technique. As used herein, “a multiple projection X-ray system” refers to an imaging system wherein multiple X-ray projection images may be collected at different angles relative to the imaged anatomy, such as, for example, tomosynthesis systems, CT systems and C-Arm systems.

In the embodiment illustrated in FIG. 1, tomosynthesis system 10 includes a source 12 of X-ray radiation, which is movable generally in a plane, or in three dimensions. In the exemplary embodiment, the X-ray source 12 typically includes an X-ray tube and associated support and filtering components.

A stream of radiation 14 is emitted by source 12 and passes into a region of a subject, such as a human patient 18. A collimator 16 serves to define the size and shape of the X-ray beam 14 that emerges from the X-ray source toward the subject. A portion of the radiation 20 passes through and around the subject, and impacts a detector array, represented generally by reference numeral 22. Detector elements of the array produce electrical signals that represent the intensity of the incident X-ray beam. These signals are acquired and processed to reconstruct an image of the interior structures of the subject.

Source 12 is controlled by a system controller 24 which furnishes both power and control signals for tomosynthesis examination sequences, including position of the source 12 relative to the subject 18 and detector 22. Moreover, detector 22 is coupled to the system controller 24, which commands acquisition of the signals generated by the detector 22. The system controller 22 may also execute various signal processing and filtration functions, such as for initial adjustment of dynamic ranges, interleaving of digital image data, and so forth. In general, the system controller 24 commands operation of the imaging system to execute examination protocols and to process acquired data. In the present context, the system controller 24 also includes signal processing circuitry, typically based upon a general purpose or application-specific digital computer, associated memory circuitry for storing programs and routines executed by the computer, as well as configuration parameters and image data, interface circuits, and so forth.

In the embodiment illustrated in FIG. 1, the system controller 24 includes an X-ray controller 26, which regulates generation of X-rays by the source 12. In particular, the X-ray controller 26 is configured to provide power and timing signals to the X-ray source. A motor controller 28 serves to control movement of a positional subsystem 32 that regulates the position and orientation of the source with respect to the subject and detector. The positional subsystem may also cause movement of the detector, or even the patient, rather than or in addition to the source. It should be noted that in certain configurations, the positional subsystem 32 may be eliminated, particularly where multiple addressable sources 12 are provided. In such configurations, projections may be attained through the triggering of different sources of X-ray radiation positioned accordingly. Finally, in the illustration of FIG. 1, detector 22 is coupled to a data acquisition system 30 that receives data collected by read-out electronics of the detector 22. The data acquisition system 30 typically receives sampled analog signals from the detector and converts the signals to digital signals for subsequent processing by a computer 34. Such conversion, and indeed any preprocessing, may actually be performed to some degree within the detector assembly itself.

Processor 34 is typically coupled to the system controller 24. Data collected by the data acquisition system 30 is transmitted to the processor 34 and, moreover, to a memory device 36. Any suitable type of memory device may be adapted to the present technique, particularly memory devices adapted to process and store large amounts of data produced by the system. Moreover, processor 34 is configured to receive commands and scanning parameters from an operator via an operator workstation 38, typically equipped with a keyboard, mouse, or other input devices. An operator may control the system via these devices, and launch examinations for acquiring image data. Moreover, processor 34 is adapted to perform reconstruction of the image data. Where desired, other computers or workstations may perform some or all of the functions of the present technique, including post-processing of image data simply accessed from memory device 36 or another memory device at the imaging system location or remote from that location.

The processor 34 is typically used to control the entire tomosynthesis system 50. The processor may also be adapted to control features enabled by the system controller 24. Further, the operator workstation 38 is coupled to the processor 34 as well as to a display 40, so that the acquired projection images as well as the reconstructed volumetric image may be viewed.

In the diagrammatical illustration of FIG. 1, a display 40 is coupled to the operator workstation 38 for viewing reconstructed images and for controlling imaging. Additionally, the image may also be printed or otherwise output in a hardcopy form via a printer 42. The operator workstation, and indeed the overall system may be coupled to large image data storage devices, such as a picture archiving and communication system (PACS) 44. The PACS 44 may be coupled to a remote client, as illustrated at reference numeral 46, such as for requesting and transmitting images and image data for remote viewing and processing as described herein. It should be further noted that the processor 34 and operator workstation 38 may be coupled to other output devices, which may include standard or special-purpose computer monitors, computers and associated processing circuitry. One or more operator workstations 38 may be further linked in the system for outputting system parameters, requesting examinations, viewing images, and so forth. In general, displays, printers, workstations and similar devices supplied within the system may be local to the data acquisition components or, as described above, remote from these components, such as elsewhere within an institution or in an entirely different location, being linked to the imaging system by any suitable network, such as the Internet, virtual private networks, Ethernets, and so forth.

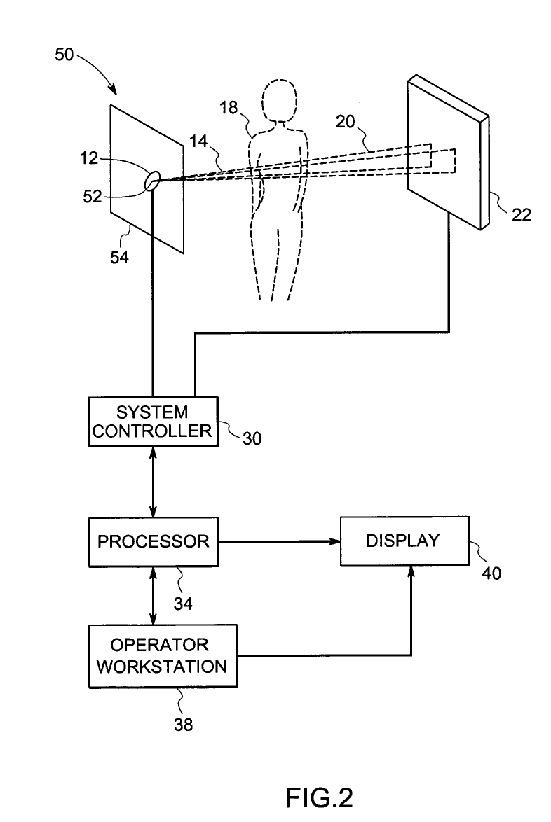

Referring generally to FIG. 2, an exemplary implementation of a tomosynthesis imaging system of the type discussed with respect to FIG. 1 is illustrated. As shown in FIG. 2, an imaging scanner 50 generally permits interposition of a subject 18 between the source 12 and detector 22. Although a space is shown between the subject and detector 22 in FIG. 2, in practice, the subject may be positioned directly before the imaging plane and detector. The detector may, moreover, vary in size and configuration. The X-ray source 12 is illustrated as being positioned at a source location or position 52 for generating one of a series of projections. In general, the source is movable to permit multiple such projections to be attained in an imaging sequence. In the illustration of FIG. 2, a source plane 52 is defined by the array of positions available for source 12. The source plane 54 may, of course, be replaced by three-dimensional trajectories for a movable source. Alternatively, two-dimensional or three-dimensional layouts and configurations may be defined for multiple sources, which may or may not be independently movable.

In typical operation, X-ray source 12 emits an X-ray beam from its focal point toward detector 22. A portion of the beam 14 that traverses the subject 18, results in attenuated X-rays 20 which impact detector 22. This radiation is thus attenuated or absorbed by the internal structures of the subject, such as internal anatomies in the case of medical imaging. The detector is formed by a plurality of detector elements generally corresponding to discrete picture elements or pixels in the resulting image data. The individual pixel electronics detect the intensity of the radiation impacting each pixel location and produce output signals representative of the radiation. In an exemplary embodiment, the detector consists of an array of 2048×2048, with a pixel size of 100×100 μm. Other detector configurations and resolutions are, of course, possible. Each detector element at each pixel location produces an analog signal representative of the impending radiation that is converted to a digital value for processing.

Source 12 is moved and triggered, or distributed sources are similarly triggered, to produce a plurality of projections or images from different source locations. These projections are produced at different view angles and the resulting data is collected by the imaging system. In an exemplary embodiment, the source 12 is positioned approximately 180 cm from the detector, in a total range of motion of the source between 31 cm and 131 cm, resulting in a 5° to 20° movement of the source from a center position. In a typical examination, many such projections may be acquired, typically thirty or less, although this number may vary.

Data collected from the detector 22 then typically undergo correction and pre-processing to condition the data to represent the line integrals of the attenuation coefficients of the scanned objects, although other representations are also possible. The processed data, commonly called projection images, are then typically input to a reconstruction algorithm to formulate a volumetric image of the scanned volume. In tomosynthesis, a limited number of projection images are acquired, typically thirty or less, each at a different angle relative to the object and/or detector. Reconstruction algorithms are typically employed to perform the reconstruction on this projection image data to produce the volumetric image.

Once reconstructed, the volumetric image produced by the system of FIGS. 1 and 2 reveals the three-dimensional characteristics and spatial relationships of internal structures of the subject 18. Reconstructed volumetric images may be displayed to show the three-dimensional characteristics of these structures and their spatial relationships. The reconstructed volumetric image is typically arranged in slices. In some embodiments, a single slice may correspond to structures of the imaged object located in a plane that is essentially parallel to the detector plane. Though the reconstructed volumetric image may comprise a single reconstructed slice representative of structures at the corresponding location within the imaged volume, more than one slice image is typically computed.

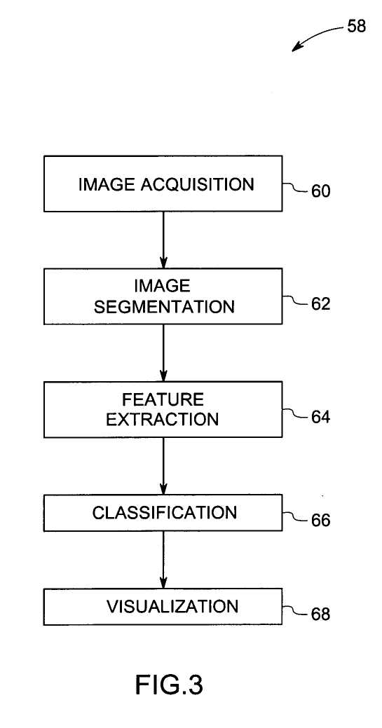

FIG. 3 is a flow chart illustrating exemplary steps for carrying out CAD processing of image data, as applied to tomographic image data from a system of the type illustrated in FIGS. 1 and 2. As will be appreciated by those skilled in the art, CAD algorithms may be considered as including several parts or modules. A CAD algorithm, in general, includes modules for accessing image data, segmenting images, feature extraction, classification, training, and visualization. Moreover, as mentioned above, processing by a CAD algorithm may be performed on a two-dimensional reconstructed image, on a three-dimensional reconstructed image (volume data or multiplanar reformats), or a suitable combination of such formats. Three-dimensional imaging may be restricted to a slice, where the source trajectory lies in the plane spanned by the reconstructed slice, and the detector array may be one-dimensional, also positioned in that plane. In more general scenarios, in case of area detectors, the source may follow more general trajectories. Using the acquired or reconstructed image, segmentation, feature extraction and classification prior to visualization may be performed. These basic processes, as will be described in greater detail below, may be performed in parallel, or in various combinations.

Referring to FIG. 3 now, an image acquisition step 60 is initially performed. The image data may originate from a tomographic data source, or may be diagnostic tomographic data (such as raw data in the projection domain or Radon domain in CT imaging, single or multiple reconstructed two-dimensional images, or three-dimensional reconstructed volumetric image data), and may also be data that was acquired previously, that is now being read from a PACS, or other storage or archival system. In accordance with a particular embodiment of the present technique, the projection images are accessed from the tomosynthesis system 10, as described in FIG. 1 and FIG. 2.

The image segmentation step of a CAD algorithm is indicated in step 62. The segmentation step identifies a set of segments in a reconstructed image. These segments may be regions that may or may not overlap each other, and the regions taken together may or may not cover the entire image. The segments may also be simply points (3D locations) from the image. The segmentation may also simply be a fixed grid of points, and not selected based on the image content. Each segment is used as an individual unit for the feature extraction stage and the classification stage, though it is also possible for those stages to have some effect on the segments, by adding, removing, combining, or splitting them. The particular segmentation technique may depend upon the anatomies to be identified, and may typically be based upon two-and three dimensional linear filtering, two-and three dimensional non-linear filtering, iterative thresholding, K-means segmentation, edge detection, edge linking, curve fitting, curve smoothing, two- and three-dimensional morphological filtering, region growing, fuzzy clustering, image/volume measurements, heuristics, knowledge-based rules, decision trees, neural networks, and so forth. Alternatively, the segmentation may be at least partially manual. Automated segmentation may also use prior knowledge such as typical shapes and sizes of anomalies to automatically delineate an area of interest. Segments may also be manually selected regions of interest, which may also be determined from markers (for example, placed in or on the imaged anatomy after a physicians examination), or using other information (for example, some form of prior knowledge about the location of a region of interest, or for example, from another modality in a co-registered acquisition). A segment may also comprise the whole reconstructed volume.

The feature extraction step of a CAD algorithm is indicated in step 64. This step involves computing features for each segment by performing computations on the reconstructed image. Multiple feature measures can be extracted from the image-based data, such as texture measures, filter-bank responses, segment shape, segment size, segment density, and segment curvature.

The classification step of the CAD algorithm is indicated in step 66. Based on the features for each segment, the classifier assigns each segment to a class. The result of this assignment is a “classification map” that gives the assigned class for each segment. Classes are selected to represent the various normal anatomic signatures and also the signatures of anatomic anomalies the CAD system is designed to detect. Some examples of classes for mammography are, “glandular tissue”, “lymph node”, “spiculated mass”, “calcification cluster”. However, the names of the classes may vary widely and their meanings in a particular CAD system may be more abstract than these simple examples. Bayesian classifiers, neural networks, rule-based methods or fuzzy logic techniques, among others, can be used for classification. In addition to assigning each segment to a class, the classifier may output a confidence measure associated with that assignment. The confidence measures may be kept in a “confidence map” that gives the confidence for each corresponding entry in the classification map. The confidence measure may be an estimated probability. Confidence measures are useful in setting thresholds as to what is displayed to the radiologist, and in combining the output from multiple CAD algorithms, discussed below.

It should be noted that more than one CAD algorithm may be employed in parallel. Such parallel operation may involve performing CAD operations individually on portions of the image data, and combining the results of all CAD operations (logically by “and”, “or” operations or both, “weighted averaging”, or probabilistic reasoning”). In addition, CAD operations to detect multiple disease states or anatomical signatures of interest may be performed in series or in parallel.

Prior to using the CAD algorithm on real images, prior knowledge from training images may be incorporated. The training phase may involve the computation of candidate features on known samples of normal and abnormal lesions or other signatures of interest in order to determine which of the candidate features should be used on real (non-training) images. A feature selection algorithm may then be employed to sort through the candidate features and select only the useful ones and remove those that provide no information, or redundant information. This decision is based upon classification results with different combinations of the candidate features. The feature selection algorithm may also be used to reduce the dimensionality for practical reasons of processing, storage and data transmission. Thus, optimal discrimination may be performed between signatures or anatomies identified by the CAD algorithm.

Finally, the visualization aspect of the CAD algorithm, indicated in step 68, permits reconstruction of useful images for review by human or machine observers. Thus, various types of images may be presented to the attending physician or to any other person needing such information, based upon any or all of the processing and modules performed by the CAD algorithm. The visualization may include two-or three-dimension renderings, superposition of markers, color or intensity variations, and so forth. The findings from the reconstructions (as generated by the CAD algorithm) can be geometrically mapped to, and displayed superimposed on projection images, or a 3D reconstructed image that was generated specifically for visualization, for display. The findings can also be displayed superimposed on a subset or all of the generated reconstructed volumes. Location of findings can also be mapped to an image from another modality (if available), and the other modality can be displayed, with the CAD results superimposed. The other modality can also be displayed simultaneously, either in a separate image, or superimposed in some way. The CAD results are stored for archival—maybe together with all or a subset of the generated data (projections and/or reconstructed 3D volumes)

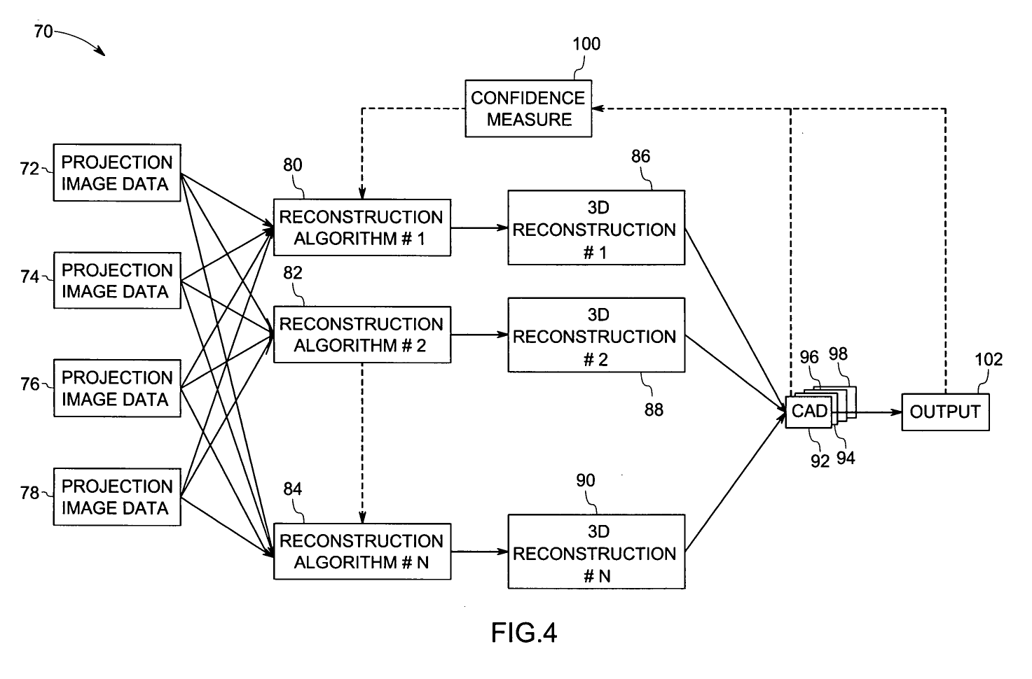

FIG. 4 is an illustration of a CAD system that is configured to operate on multiple reconstructions, in accordance with one embodiment of the present technique. The CAD system 70 as shown in FIG. 4, utilizes one or more CAD algorithms, indicated, generally by the reference numerals, 92, 94 96 and 98, which each compute features for each sample point, or segmented region in the image. The features are generally assembled into a feature vector. As is known to those skilled in the art, each feature vector represents a parameter or a set of parameters that is designed or selected to help discriminate between a diseased tissue and a normal tissue. These feature vectors are designed or selected to respond to the structure of cancerous tissue, such as calcification, spiculation, mass margin and mass shape, in a way that distinguishes cancerous tissue from normal tissue. In particular, the discriminating power of each of these feature vectors depends on the reconstruction being used. Examples of components of a feature vector include, reconstruction pixel values themselves, texture measures, size and shape of a segmented object, filter responses, wavelet filter responses, measures of the mass margin, or measures indicating the degree of spiculation.

The feature vectors are sent to a classifier, such as a neural network, a Bayesian classifier, a decision tree, or a support vector machine. As with CAD systems that operate on a single reconstructed image, the classifier assigns each segment to a class. This assignment amounts to a decision made by the CAD system, which may simply indicate whether the point or region appears to be cancer, or the classifier may choose more specifically what it thinks the tissue is in the region, from a set of types of cancer and normal anatomy.

In accordance with the present technique, and as mentioned above, the CAD system 70 is adapted to compute and evaluate features that come from several different reconstructions. As is known to those skilled in the art, different reconstruction algorithms have different characteristics (e.g., noise characteristics, shape and structure of reconstruction artifacts, etc.) and thus reveal different anatomical signatures to a greater or lesser extent. The application of a specific reconstruction algorithm to a set of projection images may also depend on the structure of the imaged object. That is, for the imaging of certain objects, the application of a certain reconstruction algorithm may generate a “good” image of an object, whereas for some other, different object, a different reconstruction algorithm may be used to generate a “good” image of the object. A “good” image may be particularly useful for a specific purpose (e.g., visualization), while it may be less well suited for another purpose (e.g., a specific CAD algorithm). In general, different reconstruction algorithms form reconstructions with different characteristics. Also, different parameters used with a particular reconstruction algorithm may also result in a reconstruction with different characteristics.

Therefore, in accordance with a particular aspect of the present invention, and as will be described in greater detail below, a technique is disclosed, wherein multiple reconstructions are input into a CAD algorithm in order to improve detection or diagnosis. When multiple reconstructions are used, the same features may be computed on each of the reconstructions or a subset of the features may be selected and used for each of the reconstructions, or different sets of features may be computed on the plurality of reconstructions. The combined set of features, or a subset of it, is then given to the classifier, or the features computed for each reconstruction are fed to separate classifiers and the outputs from those classifiers are combined to make a decision. The classifier may explicitly or implicitly generate an output parameter showing the confidence in the decision made. This parameter may be probabilistic. For example, as will be appreciated by those skilled in the art, a Bayesian classifier produces likelihood ratios that reflect confidence in the decision made. On the other hand, classifiers, such as decision trees, that do not have an intrinsic confidence measure can be easily extended by assigning a confidence to each output, for example, based on the error rate on training data.

Referring to FIG. 4 again, one or more CAD algorithms, indicated generally by the reference numerals, 92, 94, 96 and 98, are applied to a plurality of reconstructed images, indicated by the reference numerals, 86, 88 and 90. In accordance with a particular embodiment, applying the CAD algorithm comprises creating a classification map, possibly with a confidence map or creating a list of detections including locations and possibly confidence measures.

Initially, projection image data (as indicated by the reference numerals, 72, 74, 76 and 78) are accessed from the tomosynthesis system as described in FIG. 1 (or from another imaging system, or a PACS system, etc). A plurality of reconstruction algorithms (indicated generally, by the reference numerals, 80, 82 and 84), are applied on the projection images to generate a plurality of reconstructed images.

Referring to FIG. 4 again, a number of reconstruction algorithms may be used to generate the reconstructed image data. In particular, the reconstruction algorithms may include a simple backprojection algorithm, an order statistics based backprojection (OSBP) algorithm, a generalized filtered backprojection (GFBP) algorithm, an algebraic reconstruction (ART) algorithm, a direct ART algorithm (DART) a matrix inversion tomosynthesis (MITS) algorithm, and a Fourier based reconstruction algorithm and a maximum likelihood reconstruction algorithm. Other reconstruction algorithms known in the art may be used as well.

As will be appreciated by those skilled in the art, an order statistics-based backprojection is similar to a simple backprojection reconstruction. Specifically, in order statistics based backprojecting, the averaging operator that is used to combine individual backprojected image values at any given location in the reconstructed volume is replaced by an order statistics operator. Thus, instead of simply averaging the backprojected pixel image values at each considered point in the reconstructed volume, an order statistics based operator is applied on a voxel-by-voxel basis. Depending on the specific framework, different order statistics operators may be used (e.g., minimum, maximum, median, etc.), but in breast imaging, an operator which averages all values with the exception of some maximum and some minimum values is preferred. More generally, an operator which computes a weighted average of the sorted values can be used, where the weights depend on the ranking of the backprojected image values. In particular, the weights corresponding to some maximum and some minimum values may be set to zero.

The ART reconstruction technique is an iterative reconstruction algorithm in which computed projections or ray sums of an estimated image are compared with the original projection measurements and the resulting errors are applied to correct the image estimate. The direct algebraic reconstruction technique (DART), as discussed in U.S. patent application Ser. No. 10/663,309, is hereby incorporated by reference. DART comprises filtering and combining the projection images followed by a simple backprojection to generate a three-dimensional reconstructed image. The Generalized Filtered Backprojection algorithm consists of a 2D filtering followed by an order statistics-based backprojection. Matrix Inversion Tomosynthesis consists essentially of a simple backprojection (such as, for example, shift and add), followed by a deconvolution with the associated point spread function in Fourier space. A Fourier space based reconstruction algorithm essentially combines a solution of the projection equations in Fourier space with a simple parallel-beam backprojection in Fourier space. In a Maximum-Likelihood (ML) reconstruction, an estimate of the reconstructed volume is iteratively updated such as to optimize the fidelity of the reconstruction with the collected projection data. Specifically, the fidelity term is interpreted here in a probabilistic manner.

In accordance with another aspect of the present technique, the plurality of reconstructed images, 86, 88 and 90 that are input into the CAD algorithm, are distinguished based on one or more reconstruction parameters. The reconstruction parameters may comprise a spatial resolution parameter, a pixel size parameter, a filter parameter, a weight parameter and an input projection image set associated with a reconstruction algorithm.

As discussed above, the application of different reconstruction algorithms, and/or different parameter settings to projection images, results in the creation of multiple image datasets (reconstructions) that exhibit different characteristics (or appearances). For example, in the GFBP reconstruction technique, the filter parameters may be modified. The filter may generally correspond to a two-dimensional (2D) filter with a high-pass characteristic. In accordance with the present technique, the symmetry of the filter as well as the high-pass characteristic may be modified. Similarly, in the OSBP reconstruction technique, typically, a “backprojected value” is determined as the average of all backprojected pixel values with the exception of the maximum and minimum values, which are discarded. Both the number of maximum and minimum values that are discarded may be modified to generate reconstructed images with different characteristics. In the DART reconstruction technique, intermediate images that are combinations of filtered versions of all projection images are created, and then reconstructed using simple backprojection. A wide range of parameters may be modified in this setting, such as, for example, filter parameters. As is known to those skilled in the art, for N projection images N×N filters are present, every single one of which may be modified separately. In addition, the simple backprojection in DART may be replaced by OSBP or Weighted Backprojection (WBP), wherein both these techniques have their own parameters that may be modified. In particular, in WBP, the weights are typically data-dependent and the mapping from data to weights may be chosen differently for different situations.

In addition, certain reconstruction algorithms are capable of generating both a reconstructed image and an associated variance image. As is known to those skilled in the art, the reconstruction is essentially an estimate of some aspect of the tissue being imaged, at each sample point. The variance image, for each sample point in the reconstruction, gives a variance on that estimate. Therefore, in accordance with yet another aspect of the present technique, the variance image may also be used as input by the CAD algorithm to improve the decision process.

In another embodiment of the present technique, the reconstruction algorithms may also differ from one another based on the sample spacing parameter or alternatively, the pixel size parameter. That is, a reconstruction for tomosynthesis may typically be computed on a grid with spacing of 0.1 mm, 0.1 mm, 1.0 mm (X, Y, Z). However, a reconstruction algorithm may also produce a reconstruction on a grid with spacing of, for example, 0.5 mm, 0.5 mm, 1.0 mm (X, Y, Z).

In accordance with another embodiment of the present technique, at least one further reconstruction may additionally be performed based upon the results of the CAD algorithm. That is, a CAD algorithm may request for additional reconstructions to be performed in a particular region of interest, if it is unable to effectively classify the region of interest. As indicated in FIG. 4 (by the feedback block 100), if the classification of the whole scan, or parts of the scan cannot be made with confidence above some threshold, the CAD system 70 may request for additional different reconstructions to be used as additional inputs. In particular, the reconstruction algorithm, or specific parameters of the requested additional reconstruction, may also depend on the output of the first reconstruction. Further, in accordance with this embodiment, the at least one further reconstruction that is input into the CAD algorithm may have distinct reconstruction parameter settings of its own as well as an associated variance image, as mentioned above. Furthermore, the at least one further reconstruction may be performed on a data set from a different imaging modality.

Further, in accordance with yet another aspect of the present technique, the plurality of reconstructed images, 86, 88 and 90 may each initially be generated from projection images that comprise a first subset of an input projection image set, and the at least one further reconstruction may be performed based upon a different subset of projection images that comprise the input projection image set. Therefore, in accordance with this aspect, and as mentioned above, another parameter that may be set for any reconstruction algorithm is the set of projection images that are used as input to the algorithm. As will be appreciated by those skilled in the art, generally, all of the projection images are used to produce a reconstructed image, but this may not always be the case. In some cases, the projection images may be produced using different X-ray settings, such as, the X-ray energy (keV). Also, some of the projection images may be generated with the X-ray source at a more extreme angle to the detector panel, than other projection images. Therefore, the plurality of reconstructed images may also differ based on their corresponding input sets of projection images. Further, in accordance with this aspect, each reconstructed image comprising the plurality of reconstructed images may be produced by applying a reconstruction algorithm to a set of projection images that is different from the projection images that comprise the input projection data set.

In accordance with yet another aspect of the present technique, one or more additional projection images, that are not a part of the input projection image set may be acquired and subsequently processed, based on the results of the CAD algorithm. Therefore, in accordance with this embodiment, a targeted tomographic acquisition of a region of interest may be obtained, using additional projection images that are not a part of the originally collected input projection image data set, at a plurality of view angle positions. Finally, as shown by the output block 102 in FIG. 4, the results of the CAD algorithm may be displayed to a user.

The embodiments illustrated above may comprise a listing of executable instructions for implementing logical functions. The listing can be embodied in any computer-readable medium for use by or in connection with a computer-based system that can retrieve, process and execute the instructions. Alternatively, some or all of the processing may be performed remotely by additional computing resources.

In the context of the present technique, the computer-readable medium may be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for performing a computer aided detection (CAD) analysis of images acquired from a multiple projection X-ray system, the method comprising:
accessing the projection images from the multiple projection X-ray system;
applying a plurality of reconstruction algorithms on the projection images to generate a plurality of reconstructed images; and
applying a CAD algorithm to the plurality of reconstructed images.

2. The method of claim 1, wherein applying the CAD algorithm comprises creating at least one of a map of detected signatures of interest, one or more regions of interest and a map of probabilities of malignancy.

3. The method of claim 1, wherein the multiple projection X-ray system comprises at least one of a tomosynthesis system, a CT system and a C-arm system.

4. The method of claim 1 comprising performing at least one further reconstruction based upon the results of the CAD algorithm, and wherein the CAD algorithm is applied to the at least one further reconstruction.

5. The method of claim 4, wherein the at least one further reconstruction is performed for a region of interest, based upon the results of the CAD algorithm.

6. The method of claim 4, wherein the at least one further reconstruction is performed on a projection data set from a different imaging modality.

7. The method of claim 1, wherein the plurality of reconstruction algorithms comprise at least one of a simple backprojection algorithm, an order statistics based backprojection (OSBP) algorithm, a generalized filtered backprojection (GFBP) algorithm, an algebraic reconstruction (ART) algorithm, a direct algebraic reconstruction (DART) algorithm, a matrix inversion tomosynthesis (MITS) algorithm, a Fourier based reconstruction algorithm and a maximum likelihood reconstruction algorithm.

8. The method of claim 4, wherein the plurality of reconstructed images and the at least one further reconstruction to which the CAD algorithm is applied, are distinguished based on at least one of a reconstruction algorithm and one or more reconstruction parameters.

9. The method of claim 8, wherein the reconstruction parameters comprise at least one of a spatial resolution parameter, a pixel size parameter, a filter parameter, a weight parameter and an input projection image set associated with a reconstruction algorithm.

10. The method of claim 9, wherein the plurality of reconstructed images are generated from projection images that comprise a first subset of the input projection image set, and wherein the at least one further reconstruction is performed based upon a different subset of projection images that comprise the input projection image set.

11. The method of claim 10, further comprising acquiring and processing one or more additional projection images based on the results of the CAD algorithm, wherein the one or more additional projection images are not a part of the input projection image set.

12. The method of claim 4, wherein the plurality of reconstructed images and the at least one further reconstruction that are input into the CAD algorithm includes an associated variance image.

13. The method of claim 1, further comprising displaying the results of the CAD algorithm to a user.

14. A method for performing a computer aided detection (CAD) analysis of projection images acquired from a multiple projection X-ray system, the method comprising:
accessing the projection images from the multiple projection X-ray system;
applying a reconstruction algorithm on the projection images to generate a reconstructed image;
applying a CAD algorithm to the reconstructed image; and
performing at least one further reconstruction based upon the results of the CAD algorithm.

15. The method of claim 14, wherein applying the CAD algorithm comprises creating at least one of a map of detected signatures of interest, one or more regions of interest and a map of probabilities of malignancy.

16. The method of claim 14, wherein the multiple projection X-ray system comprises at least one of a tomosynthesis system, a CT system and a C-arm system.

17. The method of claim 14, wherein the at least one further reconstruction is performed on a projection data set from a different imaging modality.

18. The method of claim 14, further comprising applying a plurality of reconstruction algorithms on the projection images to generate a plurality of reconstructed images.

19. The method of claim 18, wherein the plurality of reconstruction algorithms comprise at least one of a simple backprojection algorithm, an order statistics based backprojection (OSBP) algorithm, a generalized filtered backprojection (GFBP) algorithm, an algebraic reconstruction (ART) algorithm, a direct algebraic reconstruction (DART) algorithm, a matrix inversion tomosynthesis (MITS) algorithm, and a Fourier based reconstruction algorithm and a maximum likelihood reconstruction algorithm.

20. The method of claim 14, wherein the reconstructed images and the at least one further reconstruction, are distinguished based on at least one of a reconstruction algorithm, and one or more reconstruction parameters.

21. The method of claim 14, wherein the reconstructed images are generated from projection images that comprise a first subset of an input projection image set, and wherein the at least one further reconstruction is performed based upon a different subset of projection images that comprise the input projection image set.

22. The method of claim 21, further comprising acquiring and processing one or more additional projection images based on the results of the CAD algorithm, wherein the one or more additional projection images are not a part of the input projection image set.

23. A method for performing a computer aided detection (CAD) analysis of projection images acquired from a tomosynthesis system, the method comprising:
accessing the projection images from the tomosynthesis system;
applying a plurality of reconstruction algorithms on the projection images to generate a plurality of reconstructed images;
applying a CAD algorithm to the plurality of reconstructed images; and
performing at least one further reconstruction based upon the results of the CAD algorithm.

24. The method of claim 23, wherein applying the CAD algorithm comprises creating at least one of a map of detected signatures of interest, one or more regions of interest and a map of probabilities of malignancy.

25. The method of claim 23, wherein the plurality of reconstructed images and the at least one further reconstruction to which the CAD algorithm is applied, are distinguished based on at least one of a reconstruction algorithm and one or more reconstruction parameters.

26. The method of claim 23, wherein the plurality of reconstructed images are generated from projection images that comprise a first subset of an input projection image set, and wherein the at least one further reconstruction is performed based upon a different subset of projection images that comprise the input projection image set.

27. The method of claim 26, wherein each reconstructed image is produced by applying a reconstruction algorithm to a set of the projection images that is different from the projection images that comprise the input projection data set.

28. A multiple projection X-ray system comprising:
a source of radiation for producing X-ray beams directed at a subject of interest;
a detector adapted to detect the X-ray beams; and
a processor configured to access projection images detected by the detector, wherein the processor is further configured to apply a plurality of reconstruction algorithms on the projection images to generate a plurality of reconstructed images; and apply a CAD algorithm to the plurality of reconstructed images, wherein applying the CAD algorithm comprises creating at least one of a map of detected signatures of interest, one or more regions of interest and a map of probabilities of malignancy and wherein the multiple projection X-ray system comprises at least one of a tomosynthesis system, a CT system and a C-arm system.

29. A tangible medium for performing a computer aided detection (CAD) analysis of images acquired from a tomosynthesis system, the method comprising:
a routine for accessing projection images from the tomosynthesis system;
a routine for applying a plurality of reconstruction algorithms on the projection images to generate a plurality of reconstructed images; and
a routine for applying a CAD algorithm to the plurality of reconstructed images, wherein applying the CAD algorithm comprises creating at least one of a map of detected signatures of interest, one or more regions of interest and a map of probabilities of malignancy.
